(19) United States
(12) Patent Application Publication
(10) Pub. No.: US 2019/0147464 A1
(43) Pub. Date: May 16, 2019

(54) METHOD AND APPARATUS FOR CLEARING ELECTRIC QUANTITY MARKET

(71) Applicant: Tsinghua University, Beijing (CN)

(72) Inventors: Qixin CHEN, Beijing (CN); Hongye GUO, Beijing (CN); Qing XIA, Beijing (CN); Chongqing KANG, Beijing (CN)

(21) Appl. No.: 16/028,851

(22) Filed: Jul. 6, 2018

(30) Foreign Application Priority Data
Nov. 16, 2017 (CN) 201711139529.1

(51) Int. Cl. G06Q 30/02; G06Q 50/06

(52) U.S. Cl. CPC G06Q 30/0202; G06Q 50/06

(57) ABSTRACT

Disclosed is a method for clearing electric quantity market, including: acquiring a RSI of each of a plurality of market entities; judging whether a market power exceeds a threshold according to the RSI of the market entity; adjusting an electric quantity declared by a power generation entity and a market demand electric quantity; evaluating the market power under a new environment and judging whether the market power meets a preset condition; adjusting a quoting function of each of the plurality of market entities in a CTCP and acquiring an adjustment situation; clearing transactions of each of the plurality of market entities in the CTCP according to the adjustment situation and acquiring a market clearing situation of the CTCP; distributing a CPSP in the preset electric quantity market according to the market clearing situation of the CTCP; and settling and clearing transactions according to a clearing amount and a clearing price.

### CROSS-REFERENCE TO RELATED APPLICATION

This application claims priority to and benefits of Chinese Patent Application Serial No. 201711139529.1, filed with the State Intellectual Property Office of P. R. China on Nov. 16, 2017, the entire content of which is incorporated herein by reference.

### FIELD

The present disclosure relates to the field of electric quantity market, and more particularly to a method and a device for clearing electric quantity market.

### BACKGROUND

In a mid-long term electric power market, problems, such as unfair competition using available market power by the entity with a large market share may exist. Specifically, some market entities may raise a market clearing price by physical withholding or economic withholding to gain excess profits.

In order to describe situations of market power in detail and avoid unfair competition of using the market power by some entities, a lot of researches have been done on the situations of market power in the related art, and a series of indexes reflecting market power, such as a market structure, a market performance and a market supply, have been designed.

### SUMMARY

The present disclosure seeks to solve at least one of the problems that exist in the related art to at least some extent.

For this, embodiments of a first aspect of the present disclosure provide a method for clearing electric quantity market, including:

acquiring a residual supply index RSI of each of a plurality of market entities;

judging whether a market power of a market entity exceeds a threshold according to the RSI of the market entity;

adjusting an electric quantity declared by a power generation entity and a market demand electric quantity if the market power of the market entity exceeds the threshold;

evaluating the market power under a new environment and judging whether the market power meets a preset condition;

adjusting a quoting function of each of the plurality of market entities in a competitive transaction clearing part CTCP in a preset electric quantity market and acquiring an adjustment situation if the market power meets the preset condition;

clearing transactions of each of the plurality of market entities in the CTCP in the preset electric quantity market according to the adjustment situation and acquiring a market clearing situation of the CTCP;

distributing compulsory price settlement part CPSP in the preset electric quantity market according to the market clearing situation of the CTCP; and

settling and clearing transactions of the plurality of market entities according to a clearing amount and a clearing price.

Embodiments of a second aspect of the present disclosure provide a device for clearing electric quantity market, including a processor; and a memory for storing instructions executable by the processor; in which the processor is configured to perform the method for clearing electric quantity market as described in embodiments of the first aspect of the present disclosure.

Embodiments of a third aspect of the present disclosure provide a non-transitory computer-readable storage medium having stored therein instructions that, when executed by a processor of a terminal, cause the terminal to perform the method for clearing electric quantity market as described in embodiments of the first aspect of the present disclosure.

Additional aspects and advantages of embodiments of the present disclosure will be given in part in the following descriptions, become apparent in part from the following descriptions, or be learned from the practice of the embodiments of the present disclosure.

### BRIEF DESCRIPTION OF THE DRAWINGS

These and other aspects and advantages of embodiments of the present disclosure will become apparent and more readily appreciated from the following descriptions made with reference to the drawings as described below.

FIG. 1 is a flow chart of a method for clearing electric quantity market according to an embodiment of the present disclosure;

FIG. 2 is a flow chart of a method for clearing electric quantity market according to another embodiment of the present disclosure; and

FIG. 3 is a schematic diagram of an apparatus for clearing electric quantity according to an embodiment of the present disclosure.

### DETAILED DESCRIPTION

Reference will be made in detail to embodiments of the present disclosure. The embodiments described herein with reference to drawings are explanatory, illustrative, and used to generally understand the present disclosure. The embodiments shall not be construed to limit the present disclosure. The same or similar elements and the elements having same or similar functions are denoted by like reference numerals throughout the descriptions.

A mid-long term electric quantity market will be briefly introduced below.

The mid-long term electric quantity market consists of a competitive transaction clearing part (CTCP) and a compulsory price settlement part (CPSP), and the two parts may be cleared and settled, respectively. Specifically, before clearing the mid-long term electric quantity market, residual supply index (RSI) of each of power generation entities participating in bidding is calculated. A bidding supply quantity (BSQ) consists of competitive bidding supply quantity (CBSQ) and compulsory price supply quantity (CPSQ). Specifically, CBSQ of an adjusted market entity is in the CTCP and a final market price is dependent on supply and demand functions showing a clearing results. CPSQ of the adjusted market entity is in the CPSP and may be settled as a price-taker of the market.

In order to ensure that adjustments of electric quantity and the supply and demand functions do not affect a supply and demand level of the market, a total demand of the market will be adjusted while the supply quantity of power generation entities is divided into CBSQ and CPSQ.

In the present disclosure, by an overall market adjustment and a mode of organizing transaction and settlement of the two parts, it is ensured that each of the entities in the market no more have the possibility to use the market power to affect the market, and thus a method and apparatus for clearing electric quantity are provided.

In the following, a method and apparatus for clearing electric quantity market according to embodiments of the present disclosure are described with reference to the accompanying drawings. Firstly, the method for clearing electric quantity market according to embodiments of the present disclosure will be described with reference to the accompanying drawings.

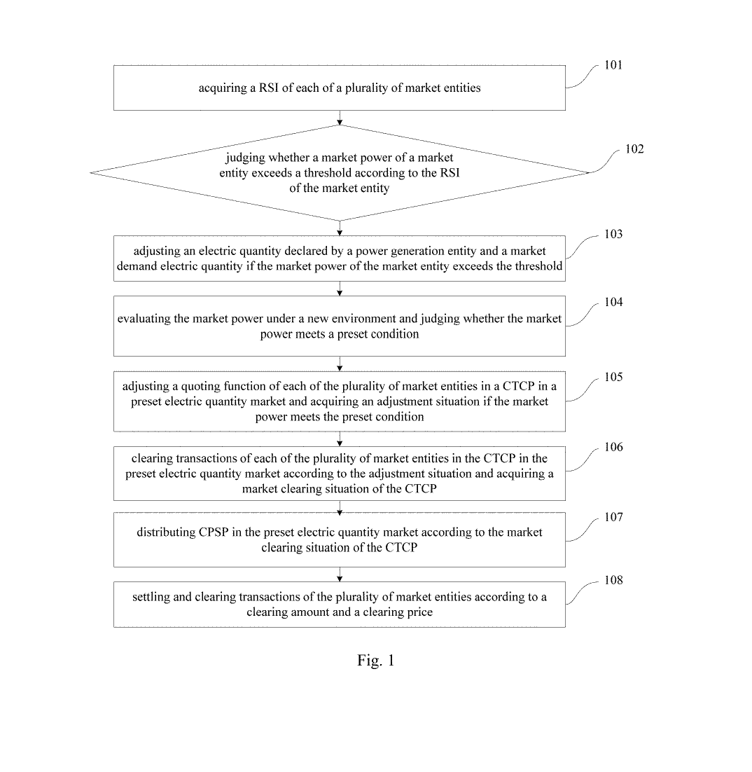

FIG. 1 is a flow chart of a method for clearing electric quantity market according to an embodiment of the present disclosure.

As shown in FIG. 1, the method for clearing electric quantity market includes the following steps.

At block 101, a RSI of each of a plurality of market entities is acquired.

Further, in an embodiment of the present disclosure, RSI of each of the plurality of market entities is calculated according to following formulas:

$${I}_{i}^{RSI} = \frac{1}{{D}_{0}} {\sum }_{j \neq i , j ∈ J} {S}_{j} , \\ {D}_{0} = {\sum }_{m ∈ M} {D}_{m} ,$$

where Iᵢ^{RSI} is a RSI of a power generation entity i, D₀ is a total demand amount of power consumption of the market, J is a set of the power generation entities participating in a bidding, Sⱼ is an upper limit of a supply quantity of a power generation entity j, M is a set of the demand entities participating in the bidding and Dₘ is a demand quantity of a power consumption entity m.

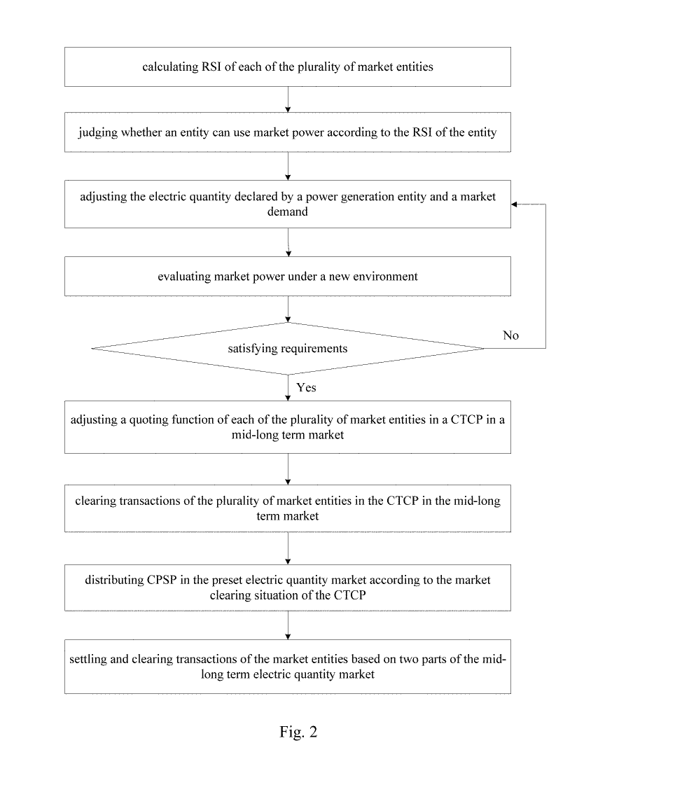

It should be understood that, as shown in FIGS. 1 and 2, in the embodiments of the present disclosure, various market entities may bid in the mid-long term electric quantity market. Specifically, the power generation entity i may bid by using a supply function ƒᵢ(p,q) (where electric quantity q is an independent variable and electric price p is a dependent variable), the upper limit of power generation and other required parameters, and the power consumption entity m may declare by using a demand function gₘ(p,q), the upper limit of power consumption, and other required parameters.

After a market operator collects all information, the RSI of each of the plurality of power generation entities is calculated according to following formulas:

$$\begin{matrix}{I}_{i}^{RSI} = \frac{1}{{D}_{0}} {\sum }_{j \neq i , j ∈ J} {S}_{j} , & ( 1 ) \\ {D}_{0} = {\sum }_{m ∈ M} {D}_{m} , & ( 2 )\end{matrix}$$

where Iᵢ^{RSI} is the RSI of a market entity i, D₀ is a total demand amount of power consumption of the market, J is a set of the market entities participating in a bidding.

Thus, the residual supply index I^{RSI} of each of the power generation entities can be obtained, that is, I^{RSI}=[I₁^{RSI} . . . Iᵢ^{RSI} . . . I_{N}^{RSI}].

At block 102, it is judged whether a market power of a market entity exceeds a threshold according to the RSI of the market entity.

It should be understood that, in the embodiments of the present disclosure, it is possible to judge whether a market power of a market entity exceeds a threshold. If the market power of the market entity does not exceed a threshold, the RSI of this power generation entity should be less than a reference RSI R₀, that is,

min(Iᵢ^{RSI})<R₀ (3).

If there is no entity i to satisfy above formula (3), it indicates that no entity can use the market power to affect the market. Then clearing of transactions of the market may be normally organized according to the supply and demand functions of the power generation entities and the power consumption entities. If there is an entity i to satisfy the formula (3), it indicates that the power generation entity i exists a possibility of using the market power. Accordingly, it is necessary to adjust the supply quantity declared by each of the power generation entities which may have a possibility to use the market power and the total market demand quantity, and the market may be divided into two sub-market parts to be organized.

At block 103, if the market power of the market entity exceeds the threshold, an electric quantity declared by a power generation entity and a market demand are adjusted.

In an embodiment of the present disclosure, the electric quantity declared by the power generation entity and the market demand are adjusted according to following formulas:

$$\{ \begin{matrix}{x}_{i} = \frac{( {S}_{0} + {nS}_{i} - {\sum }_{j ∈ E} {S}_{j} ) {R}_{0} {D}_{0} - [ {S}_{0} + ( n - 1 ) {S}_{i} - {\sum }_{j ∈ E} {S}_{j} ] {S}_{0}}{{nR}_{0} {D}_{0} - ( n - 1 ) {S}_{0}} \\ {y}_{i} = \frac{( {S}_{0} + {nS}_{i} - {\sum }_{j ∈ E} {S}_{j} ) {R}_{0} {D}_{0} - [ {S}_{0} + ( n - 1 ) {S}_{i} - {\sum }_{j ∈ E} {S}_{j} ] {S}_{0}}{{nR}_{0} {D}_{0} - ( n - 1 ) {S}_{0}} \cdot \frac{{D}_{0}}{{S}_{0}}\end{matrix} , \\ \{ \begin{matrix}{X}_{E} = {S}_{0} - \frac{{S}_{0} - {\sum }_{j ∈ E} {S}_{j}}{{nR}_{0} {D}_{0} - ( n - 1 ) {S}_{0}} {S}_{0} \\ {Y}_{E} = {D}_{0} - \frac{{S}_{0} - {\sum }_{j ∈ E} {S}_{j}}{{nR}_{0} {D}_{0} - ( n - 1 ) {S}_{0}} {D}_{0}\end{matrix} , \\ {S}_{i}^{′} = \frac{( {S}_{0} - {\sum }_{j ∈ E} {S}_{j} ) ( {S}_{0} - {R}_{0} {D}_{0} )}{{nR}_{0} {D}_{0} - ( n - 1 ) {S}_{0}} ,$$

where E is an electric quantity set of the adjusted entity i participating in a compulsory clearing market, n is the number of the power generation entities in the set E, S₀ is a total power generation supply quantity of the market, Sᵢ is an upper limit of the supply quantity of the power generation entity i, R₀ is a reference RSI, and D₀ is a total demand amount of power consumption of the market.

In an embodiment of the present disclosure, a quoting function of each of the plurality of market entities in the CTCP in a mid-long term electric quantity market is adjusted according to following formulas:

ƒᵢ′(p,q)=ƒᵢ(p,q),q∈[0,Sᵢ′],

G^{CBDQ}(p,q)=G(p,q),q∈[0,D₀−Y_{E}],

where ƒᵢ′(p,q) is the quoting function of the power generation entity i after the adjustment, p is a quoted price, q is a quoted quantity, ƒᵢ(p,q) is the quoting function of the power generation entity i before the adjustment, Sᵢ′ is an upper limit of the supply quantity of the power generation entity i after the adjustment, G^{CBDQ}(p,q) is a demand function of the competitive clearing demand electric quantity of an entire power consumption side, G(p,q) is a demand function of the entire power consumption side and Y_{E} is an electric quantity of a demand side participating in the compulsory clearing market.

Moreover, a market clearing situation of the CTCP may be acquired, and such a step may further include: solving an optimized planning problem by taking a social dividend maximization as an objective function and considering a physical constraint of a power system to acquire a market clearing result of the CTCP, in which the market clearing result includes a market price λ₀, a clearing electric quantity Qᵢ^{CBSQ} of each of the power generation entities and a clearing electric quantity Qₘ^{CBDQ} of each of power consumption entities.

It should be understood that, as shown in FIGS. 1 and 2, in the embodiments of the present disclosure, the electric quantity declared by the power generation entity and the market demand can be adjusted. For example, in the embodiment of the present disclosure, a set of the power generation entities consisting of all the power generation entities which satisfy formula (3) may form the set E, the supply quantity of each of the power generation entities i may be divided into two parts CBSQ and CPSQ which are represented as Sᵢ′ and xᵢ, respectively, and meets a following formula.

Sᵢ=Sᵢ′+xᵢ (4)

The supply quantity of the power generation entity i and the total demand of the market are adjusted according to three principles below. Firstly, the adjusted RSI of each of the power generation entities i is required to be higher than the lower limit R₀ of the reference RSI, and a formula (5) can be obtained. Secondly, the ratio of the supply and demand of the market before and after the adjustment is constant, and a formula (6) can be obtained. Thirdly, the CPDQ, which is represented as yᵢ, of the demand side corresponding to the CPSQ of the power generation side should be determined according to weight of the CPSQ of each of the power generation entities in all CPSQs of all entities, and a formula (7) is obtained.

$$\begin{matrix}\frac{{S}_{0} - {\sum }_{j \neq i , j ∈ E} {x}_{j} - {S}_{i}}{{D}_{0}^{′}} = {R}_{0} & ( 5 ) \\ {S}_{0} \text{/} {D}_{0} = {S}_{0}^{′} \text{/} {D}_{{0}^{′}} & ( 6 ) \\ \frac{{x}_{i}}{{X}_{E}} = \frac{{y}_{i}}{{Y}_{E}} & ( 7 )\end{matrix}$$

For example, auxiliary formulas (8) of relationships among the variables are as follows:

$$\{ \begin{matrix}{S}_{0} = {\sum }_{i ∈ J} {S}_{i} \\ {S}_{0}^{′} = {S}_{0} - {X}_{E} \\ {D}_{0}^{′} = {D}_{0} - {Y}_{E} \\ {X}_{E} = {\sum }_{i ∈ E} {x}_{i} \\ {Y}_{E} = {\sum }_{i ∈ E} {y}_{i}\end{matrix} \qquad ( 8 )$$

where S₀′ is a total supply quantity of the adjusted power generation entities participating in the CTCP, D₀′ is a total demand quantity of the adjusted power consumption entities participating in the CTCP, X_{E} is a sum of all the CPSQs of the adjusted power generation entities, Y_{E} is a sum of all the CPDQs.

The formulas (5)-(8) are combined to obtain CPSQ^{x}^{ᵢ} and CPDQ^{y}^{ᵢ} corresponding to each of the entities, and for ∀i∈E, it is required to meet following formulas:

$$\begin{matrix}\{ \begin{matrix}{x}_{i} = \frac{( {S}_{0} + {nS}_{i} - {\sum }_{j ∈ E} {S}_{j} ) {R}_{0} {D}_{0} - [ {S}_{0} + ( n - 1 ) {S}_{i} - {\sum }_{j ∈ E} {S}_{j} ] {S}_{0}}{{nR}_{0} {D}_{0} - ( n - 1 ) {S}_{0}} \\ {y}_{i} = \frac{( {S}_{0} + {nS}_{i} - {\sum }_{j ∈ E} {S}_{j} ) {R}_{0} {D}_{0} - [ {S}_{0} + ( n - 1 ) {S}_{i} - {\sum }_{j ∈ E} {S}_{j} ] {S}_{0}}{{nR}_{0} {D}_{0} - ( n - 1 ) {S}_{0}} \cdot \frac{{D}_{0}}{{S}_{0}}\end{matrix} , & ( 9 ) \\ \{ \begin{matrix}{X}_{E} = {S}_{0} - \frac{{S}_{0} - {\sum }_{j ∈ E} {S}_{j}}{{nR}_{0} {D}_{0} - ( n - 1 ) {S}_{0}} {S}_{0} \\ {Y}_{E} = {D}_{0} - \frac{{S}_{0} - {\sum }_{j ∈ E} {S}_{j}}{{nR}_{0} {D}_{0} - ( n - 1 ) {S}_{0}} {D}_{0}\end{matrix} , & ( 10 ) \\ {S}_{i}^{′} = \frac{( {S}_{0} - {\sum }_{j ∈ E} {S}_{j} ) ( {S}_{0} - {R}_{0} {D}_{0} )}{{nR}_{0} {D}_{0} - ( n - 1 ) {S}_{0}} , & ( 11 )\end{matrix}$$

where n is the number of the power generation entities in the set E.

Specifically, for the power generation entity i after adjustment, the CBSQ is represented as Sᵢ′, the CPSQ is represented as xᵢ, and the corresponding CPDQ of the power generation side is represented as yᵢ.

At block 104, the market power under a new environment is evaluated and it is judged whether the market power meets a preset condition.

Specifically, if the market power does not meet the preset condition, the electric quantity and the market demand electric quantity are adjusted again, that is, the electric quantity and the market demand electric quantity are adjusted until the market power meets the preset condition, If the market power meets the present condition, block 105 proceeds.

It should be understood that, in the embodiments of the present disclosure, a market power under a new environment (i.e., after adjustments of an electric quantity declared by a power generation entity and a market demand electric quantity) can be evaluated. The market power meeting the preset condition indicates that no entity has a market power that exceeds the threshold. The RSI of each of the power generation entities is calculated according to the CBSQ of the market entities after adjustment to judge whether a power generation entity having a market power exceeding the threshold exists, i.e., whether a power generation entity not meeting a request of the reference RSI constraint R₀ exists. If no RSI of the power generation entity is lower than R₀, there is no market entity to use the market power, and then the CTCP of the market may be cleared. If a RSI of a power generation entity lower than R₀ exists, there is a possibility that market power is used by the market entity, and then the block 103 is performed again to repeat iteration until no RSI of the power generation entity is lower than R₀.

At block 105, if the market power meets the preset condition, a quoting function of each of the plurality of market entities in a competitive transaction clearing part CTCP in a preset electric quantity market is adjusted and an adjustment situation is acquired.

It should be understood that, in the embodiments of the present disclosure, the quoting function of each of the plurality of market entities in a CTCP in a mid-long term electric quantity market can be adjusted. For each entity of the power generation side that includes both the CBSQ and the CPSQ, the supply function of the entity participating in the CTCP market is adjusted. For ∀i∈E, it is required to meet a following formula:

ƒᵢ′(p,q)=ƒᵢ(p,q),q∈[0,Sᵢ′] (12),

where ƒᵢ′(p,q) is a part of ƒᵢ(p,q) from 0 to Sᵢ′ in a domain of definition.

For entities on the power consumption side, the market power thereof is not considered, and part of the demand electric quantity is regarded as the CPDQ, and the amount of such demands is Y_{E}. G(p,q) is defined as a cumulative function of a demand function gₘ(p,q) of each of the entities m, then a following formula is obtained:

G^{CBDQ}(p,q)=G(p,q),q∈[0,D₀−Y_{E}] (13),

where G^{CBDQ}(p,q) is a cumulative function of the demand function of the demand side participating in the CTCP market and is a part of the G(p,q) from 0 to D₀−Y_{E} in a domain of definition.

At block 106, transactions of each of the plurality of market entities in the CTCP in the preset electric quantity market are cleared according to the adjustment situation and a market clearing situation of the CTCP is acquired.

It should be understood that, in the embodiments of the present disclosure, transactions of each of the plurality of market entities in the CTCP in the mid-long term electric quantity market can be cleared according to the adjustment situation. The power generation side includes two types of power generation entities, i.e., non-adjusted power generation entities and the adjusted power generation entities, in which the non-adjusted power generation entities participate in the market with all the bidding electric quantity and the supply functions, and the adjusted power generation entities participate in the market with CBSQ and the adjusted supply function. The entire power consumption side is regarded as one entity to participate in the market, and the bidding electric quantity is the CBDQ of the entire power consumption side and its demand function G^{CBDQ}(p,q). In the embodiments of the present disclosure, an optimized planning problem is solved by taking a social dividend maximization as an objective function and considering a physical constraint of a power system to acquire a market clearing result of the CTCP, in which the market clearing result includes a market price λ₀, a clearing electric quantity Qᵢ^{CBSQ} of each of the power generation entities and a clearing electric quantity Qₘ^{CBDQ} of each of power consumption entities.

At block 107, compulsory price settlement part CPSP in the preset electric quantity market is distributed according to the market clearing situation of the CTCP.

Further, in an embodiment of the present disclosure, for the power generation entities participating in the CPSP, that is, for ∀i∈E, a clearing amount of an entity in the CPSP is acquired, i.e., Qᵢ^{CPSQ}=yᵢ, according to the formula (9) with a price of λ₀. For the power consumption side, based on the clearing result of the CTCP, an optimized planning problem is solved by taking a maximum of residual consumption as an objective function and a physical constraint of a power system is considered to acquire a compulsory price settlement quantity Qₘ^{CPDQ} of a power consumption entity, and the price is settled with λ₀.

It should be understood that, in the embodiments of the present disclosure, the market entities from demand side and supply side in the CPSP can be matched according to the market clearing situation of the CTCP.

Specifically, for the power generation entities participating in the CPSP, that is, for ∀i∈E, a clearing amount of an entity in the CPSP is acquired, i.e., Qᵢ^{CPSQ}=yᵢ, according to the formula (9) with a price of λ₀. For the power consumption side, based on the clearing result of the CTCP, an optimized planning problem is solved by taking a maximum of residual consumption as an objective function and a physical constraint of a power system is considered to acquire a compulsory price settlement quantity Qₘ^{CPDQ} of a power consumption entity, and the price is settled with λ₀.

On this basis, transactions and matched transactions of the two market parts in the mid-long term electric quantity market may be realized.

At block 108, transactions of the plurality of market entities are settled and cleared according to a clearing amount and a clearing price.

Further, in an embodiment of the present disclosure, for the power generation entity i, a market clearing price is λ₀, a total clearing amount is:

$${Q}_{i}^{S} = \{ \begin{matrix}{Q}_{i}^{CBSQ} + {Q}_{i}^{CCSQ} , i ∈ E \\ {Q}_{i}^{CBSQ} , i ∈ J , i ∉ E\end{matrix} .$$

For the power consumption entity m, the market clearing price is λ₀, the total clearing amount is:

Qₘ^{D}=Qₘ^{CBDQ}+Qₘ^{CCDQ}.

Transactions of the power generation entity and the power consumption entity in the market are cleared according to the clearing amount and the clearing price.

It should be understood that, in the embodiments of the present disclosure, two parts of a mid-long term electric quantity market can be considered, and transaction of each of the market entities is settled and cleared. For the power generation entity i, a market clearing price is λ₀, a total clearing amount is:

$${Q}_{i}^{S} = \{ \begin{matrix}{Q}_{i}^{CBSQ} + {Q}_{i}^{CCSQ} , i ∈ E \\ {Q}_{i}^{CBSQ} , i ∈ J , i ∉ E\end{matrix} . \qquad ( 14 )$$

For the power consumption entity m, the market clearing price is λ₀, the total clearing amount is:

Qₘ^{D}=Qₘ^{CBDQ}+Qₘ^{CCDQ} (15).

Finally, transactions of the power generation entity and the power consumption entity in the market are cleared according to the clearing amount and the clearing price.

It should be noted that if there are multiple adjustments before the market is cleared, the clearing result after the market is cleared may also require multiple adjustments, which may be realized by the above method.

In conclusion, the method in the embodiments of the present disclosure is under a principle of incentive compatibility, and ensures fairness and justice in market operation after adjustment and thus is beneficial to maximizing social welfare. Specifically, with the conventional market clearing method, the power generation entities in a large market share have a large market power. For example, in some tight supply and demand situations, physical withholding or economic withholding may occur upon quoting, which raises the market clearing price at the expense of electricity quantity, and thus the entities may obtain excess profits. However, with the method of the embodiments of the present disclosure, if the market operating agencies detect the presence of some market entities having the available market power, the declared amount of these market entities is divided into two parts according to the RSI of the market. One part is an electric quantity having no market power and being allowed to participate in the market competition, and the remaining part does not participate in the market competition but be regarded as a price-taker of the market clearing price to participate in electric quantity supply and demand balance. After the adjustment, the power generation entity with a large market share no longer has a size enabling to affect the market. If such an entity still quotes according to the original strategy of withholding the electric quantity to raise the unit price of the electricity, the electric quantity of the entity may not be cleared, such that the entity not only may fail to obtain excess profits, but also may reduce their own market shares. Therefore, after the method of the embodiments of the present disclosure is applied, an entity having market power no longer possesses motivation of withholding the electric quantity to raise the unit price of the electricity, and the entity may only quote in a reasonable prise to clear more electric quantity and obtain more profits.

With the method for clearing electric quantity market according to the embodiments of the present disclosure, in case that the market entities may use the market power, the bidding electric quantity of the power generation entity having the market power is divided to participate two parts: CTCP and CPSP, thus realizing the market clearing in full competition under a constant ratio of the supply and demand of the market.

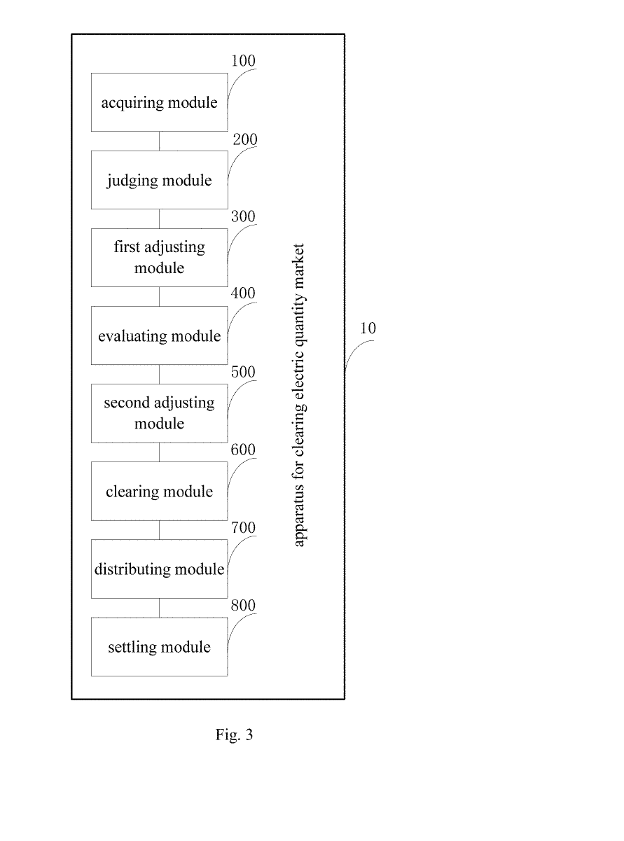

FIG. 3 is a schematic diagram of an apparatus for clearing electric quantity according to an embodiment of the present disclosure.

As shown in FIG. 3, the apparatus 10 for clearing electric quantity includes an acquiring module 100, a judging module 200, a first adjusting module 300, an evaluating module 400, a second adjusting module 500, a clearing module 600, a distributing module 700 and a settling module 800.

The acquiring module 100 is configured to acquire a RSI of each of a plurality of market entities. The judging module 200 is configured to judge whether a market power of a market entity exceeds a threshold according to the RSI of the market entity. The first adjusting module 300 is configured to adjust an electric quantity declared by a power generation entity and a market demand electric quantity if the market power of the market entity exceeds the threshold. The evaluating module 400 is configured to evaluate the market power under a new environment and judge whether the market power meets a preset condition. The second adjusting module 500 is configured to adjust a quoting function of each of the plurality of market entities in a CTCP in a preset electric quantity market and acquire an adjustment situation if the market power meets the preset condition. The clearing modules 600 is configured to clear transactions of the plurality of market entities in the CTCP in the preset electric quantity market according to the adjustment situation and acquire a market clearing situation of the CTCP. The distributing module 700 is configured to distribute compulsory price settlement part CPSP in the preset electric quantity market according to the market clearing situation of the CTCP. The settling module 800 is configured to settle and clear transactions of the market entities according to a clearing amount and a clearing price.

Further, the first adjusting module is configured to adjusting the electric quantity and the market demand electric quantity if the market power does not meet the preset condition

Further, the RSI of each of the plurality of market entities is calculated according to following formulas:

$${I}_{i}^{RSI} = \frac{1}{{D}_{0}} {\sum }_{j \neq i , j ∈ J} {S}_{j} , \\ {D}_{0} = {\sum }_{m ∈ M} {D}_{m} ,$$

where Iᵢ^{RSI} is a RSI of a power generation entity i, D₀ is a total demand amount of power consumption of the market, J is a set of the power generation entities participating in a bidding, Sⱼ is an upper limit of a supply quantity of a power generation entity j, M is a set of the demand entities participating in the bidding and Dₘ is a demand quantity of a power consumption entity m.

Further, in an embodiment of the present disclosure, the first adjusting module 300 is configured to adjust the electric quantity declared by the power generation entity and the market demand according to following formulas:

$$\{ \begin{matrix}{x}_{i} = \frac{( {S}_{0} + {nS}_{i} - {\sum }_{j ∈ E} {S}_{j} ) {R}_{0} {D}_{0} - [ {S}_{0} + ( n - 1 ) {S}_{i} - {\sum }_{j ∈ E} {S}_{j} ] {S}_{0}}{{nR}_{0} {D}_{0} - ( n - 1 ) {S}_{0}} \\ {y}_{i} = \frac{( {S}_{0} + {nS}_{i} - {\sum }_{j ∈ E} {S}_{j} ) {R}_{0} {D}_{0} - [ {S}_{0} + ( n - 1 ) {S}_{i} - {\sum }_{j ∈ E} {S}_{j} ] {S}_{0}}{{nR}_{0} {D}_{0} - ( n - 1 ) {S}_{0}} \cdot \frac{{D}_{0}}{{S}_{0}}\end{matrix} , \\ \{ \begin{matrix}{X}_{E} = {S}_{0} - \frac{{S}_{0} - {\sum }_{j ∈ E} {S}_{j}}{{nR}_{0} {D}_{0} - ( n - 1 ) {S}_{0}} {S}_{0} \\ {Y}_{E} = {D}_{0} - \frac{{S}_{0} - {\sum }_{j ∈ E} {S}_{j}}{{nR}_{0} {D}_{0} - ( n - 1 ) {S}_{0}} {D}_{0}\end{matrix} , \\ {S}_{i}^{′} = \frac{( {S}_{0} - {\sum }_{j ∈ E} {S}_{j} ) ( {S}_{0} - {R}_{0} {D}_{0} )}{{nR}_{0} {D}_{0} - ( n - 1 ) {S}_{0}} ,$$

where E is an electric quantity set of the adjusted entity i participating in a compulsory clearing market, n is the number of the power generation entities in the set E, S₀ is a total power generation supply quantity of the market, Sᵢ is an upper limit of the supply quantity of the power generation entity i, R₀ is a reference RSI, and D₀ is a total demand amount of power consumption of the market.

The second adjusting module 500 is configured to adjust the quoting function of each of the plurality of market entities in the CTCP in a mid-long term electric quantity market according to following formulas:

ƒᵢ′(p,q)=ƒᵢ(p,q),q∈[0,Sᵢ′],

G^{CBDQ}(p,q)=G(p,q),q∈[0,D₀−Y_{E}],

where ƒᵢ′(p,q) is the quoting function of the power generation entity i after the adjustment, p is a quoted price, q is a quoted quantity, ƒᵢ(p,q) is the quoting function of the power generation entity i before the adjustment, Sᵢ′ is an upper limit of the supply quantity of the power generation entity i after the adjustment, G^{CBDQ}(p,q) is a demand function of the competitive clearing demand electric quantity of an entire power consumption side, G(p,q) is a demand function of the entire power consumption side and Y_{E} is an electric quantity of a demand side participating in the compulsory clearing market.

The clearing module 600 is configured to solve an optimized planning problem by taking a social dividend maximization as an objective function and considering a physical constraint of a power system, to acquire a market clearing result of the CTCP, in which the market clearing result includes a market price λ₀, a clearing electric quantity Qᵢ^{CBSQ} of each of the power generation entities and a clearing electric quantity Qₘ^{CBDQ} of each of power consumption entities.

Further, in an embodiment of the present disclosure, the distributing module 700 is configured to: for the power generation entities participating in the CPSP, that is, ∀i∈E, acquire the clearing amount of the CPSP Qᵢ^{CPSQ}=yᵢ and settle the price with λ₀; for the power consumption side, based on the clearing result of the CTCP, solve an optimized planning problem by taking a maximum of residual consumption as an objective function and considering a physical constraint of a power system, to acquire a compulsory price settlement quantity Qₘ^{CPDQ} of a power consumption entity, and settle the price with λ₀.

Further, in an embodiment of the present disclosure, the settling module 800 is configured to clear transactions of the power generation entity and the power consumption entity in the market according to the clearing amount and the clearing price, in which for the power generation entity i, a market clearing price is λ₀, a total clearing amount is:

$${Q}_{i}^{S} = \{ \begin{matrix}{Q}_{i}^{CBSQ} + {Q}_{i}^{CCSQ} , i ∈ E \\ {Q}_{i}^{CBSQ} , i ∈ J , i ∉ E\end{matrix} ,$$

for the power consumption entity m, the market clearing price is λ₀, the total clearing amount is:

Qₘ^{D}=Qₘ^{CBDQ}+Qₘ^{CCDQ}.

It should be noted that the above explanation of the embodiments of the method for clearing electric quantity market also applies to the apparatus for clearing electric quantity in this embodiment, which is not described in detail again herein.

According to an embodiment of the present disclosure, a non-transitory computer-readable storage medium is provided having stored therein instructions that, when executed by a processor of a terminal, causes the terminal to perform a method for clearing electric quantity market according to the abovementioned embodiments of the present disclosure.

It will be understood that, the flow chart or any process or method described herein in other manners may represent a module, segment, or portion of code that includes one or more executable instructions to implement the specified logic function(s) or that includes one or more executable instructions of the steps of the progress. Although the flow chart shows a specific order of execution, it is understood that the order of execution may differ from that which is depicted. For example, the order of execution of two or more boxes may be scrambled relative to the order shown. Also, two or more boxes shown in succession in the flow chart may be executed concurrently or with partial concurrence. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure. Also, the flow chart is relatively self-explanatory and is understood by those skilled in the art to the extent that software and/or hardware can be created by one with ordinary skill in the art to carry out the various logical functions as described herein.

The logic and step described in the flow chart or in other manners, for example, a scheduling list of an executable instruction to implement the specified logic function(s), it can be embodied in any computer-readable medium for use by or in connection with an instruction execution system such as, for example, a processor in a computer system or other system. In this sense, the logic may include, for example, statements including instructions and declarations that can be fetched from the computer-readable medium and executed by the instruction execution system. In the context of the present disclosure, a “computer-readable medium” can be any medium that can contain, store, or maintain the printer registrar for use by or in connection with the instruction execution system. The computer readable medium can include any one of many physical media such as, for example, electronic, magnetic, optical, electromagnetic, infrared, or semiconductor media. More specific examples of a suitable computer-readable medium would include, but are not limited to, magnetic tapes, magnetic floppy diskettes, magnetic hard drives, or compact discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Although the device, system, and method of the present disclosure is embodied in software or code executed by general purpose hardware as discussed above, as an alternative the device, system, and method may also be embodied in dedicated hardware or a combination of software/general purpose hardware and dedicated hardware. If embodied in dedicated hardware, the device or system can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, programmable gate arrays (PGA), field programmable gate arrays (FPGA), or other components, etc. Such technologies are generally well known by those skilled in the art and, consequently, are not described in detail herein.

It can be understood that all or part of the steps in the method of the above embodiments can be implemented by instructing related hardware via programs, the program may be stored in a computer readable storage medium, and the program includes one step or combinations of the steps of the method when the program is executed.

In addition, each functional unit in the present disclosure may be integrated in one progressing module, or each functional unit exists as an independent unit, or two or more functional units may be integrated in one module. The integrated module can be embodied in hardware, or software. If the integrated module is embodied in software and sold or used as an independent product, it can be stored in the computer readable storage medium.

The computer readable storage medium may be, but is not limited to, read-only memories, magnetic disks, or optical disks.

Reference throughout this specification to “an embodiment,” “some embodiments,” “one embodiment”, “another example,” “an example,” “a specific example,” or “some examples,” means that a particular feature, structure, material, or characteristic described in connection with the embodiment or example is included in at least one embodiment or example of the present disclosure. Thus, the appearances of the phrases such as “in some embodiments,” “in one embodiment”, “in an embodiment”, “in another example,” “in an example,” “in a specific example,” or “in some examples,” in various places throughout this specification are not necessarily referring to the same embodiment or example of the present disclosure. Furthermore, the particular features, structures, materials, or characteristics may be combined in any suitable manner in one or more embodiments or examples.

Although explanatory embodiments have been shown and described, it would be appreciated by those skilled in the art that the above embodiments cannot be construed to limit the present disclosure, and changes, alternatives, and modifications can be made in the embodiments without departing from spirit, principles and scope of the present disclosure.

What is claimed is:

1. A method for clearing electric quantity market, comprising:
acquiring a residual supply index RSI of each of a plurality of market entities;
judging whether a market power of a market entity exceeds a threshold according to the RSI of the market entity;
adjusting an electric quantity declared by a power generation entity and a market demand electric quantity if the market power of the market entity exceeds the threshold;
evaluating the market power under a new environment and judging whether the market power meets a preset condition;
adjusting a quoting function of each of the plurality of market entities in a competitive transaction clearing part CTCP in a preset electric quantity market and acquiring an adjustment situation if the market power meets the preset condition;
clearing transactions of each of the plurality of market entities in the CTCP in the preset electric quantity market according to the adjustment situation and acquiring a market clearing situation of the CTCP;
distributing compulsory price settlement part CPSP in the preset electric quantity market according to the market clearing situation of the CTCP; and
settling and clearing transactions of the plurality of market entities according to a clearing amount and a clearing price.

2. The method according to claim 1, further comprising adjusting the electric quantity and the market demand electric quantity if the market power does not meet the preset condition.

3. The method according to claim 1, wherein the RSI of each of the plurality of market entities is calculated according to following formulas:
$${I}_{i}^{RSI} = \frac{1}{{D}_{0}} {\sum }_{j \neq i , j ∈ J} {S}_{j} , \\ {D}_{0} = {\sum }_{m ∈ M} {D}_{m} ,$$
where Iᵢ^{RSI} is a RSI of a power generation entity i, D₀ a total demand amount of power consumption of the market, J is a set of the power generation entities participating in a bidding, Sⱼ is an upper limit of a supply quantity of a power generation entity j, M is a set of the demand entities participating in the bidding and Dₘ is a demand quantity of a power consumption entity m.

4. The method according to claim 1, wherein adjusting an electric quantity declared by a power generation entity and a market demand electric quantity comprises:
adjusting the electric quantity declared by the power generation entity and the market demand according to following formulas:
$$\{ \begin{matrix}{x}_{i} = \frac{( {S}_{0} + {nS}_{i} - {\sum }_{j ∈ E} {S}_{j} ) {R}_{0} {D}_{0} - [ {S}_{0} + ( n - 1 ) {S}_{i} - {\sum }_{j ∈ E} {S}_{j} ] {S}_{0}}{{nR}_{0} {D}_{0} - ( n - 1 ) {S}_{0}} \\ {y}_{i} = \frac{( {S}_{0} + {nS}_{i} - {\sum }_{j ∈ E} {S}_{j} ) {R}_{0} {D}_{0} - [ {S}_{0} + ( n - 1 ) {S}_{i} - {\sum }_{j ∈ E} {S}_{j} ] {S}_{0}}{{nR}_{0} {D}_{0} - ( n - 1 ) {S}_{0}} \cdot \frac{{D}_{0}}{{S}_{0}}\end{matrix} , \\ \{ \begin{matrix}{X}_{E} = {S}_{0} - \frac{{S}_{0} - {\sum }_{j ∈ E} {S}_{j}}{{nR}_{0} {D}_{0} - ( n - 1 ) {S}_{0}} {S}_{0} \\ {Y}_{E} = {D}_{0} - \frac{{S}_{0} - {\sum }_{j ∈ E} {S}_{j}}{{nR}_{0} {D}_{0} - ( n - 1 ) {S}_{0}} {D}_{0}\end{matrix} , \\ {S}_{i}^{′} = \frac{( {S}_{0} - {\sum }_{j ∈ E} {S}_{j} ) ( {S}_{0} - {R}_{0} {D}_{0} )}{{nR}_{0} {D}_{0} - ( n - 1 ) {S}_{0}} ,$$
where E is an electric quantity set of the adjusted entity i participating in a compulsory clearing market, n is the number of the power generation entities in the set E, S₀ is a total power generation supply quantity of the market, Sᵢ is an upper limit of the supply quantity of the power generation entity i, R₀ is a reference RSI, and D₀ is a total demand amount of power consumption of the market;
adjusting the quoting function of each of the plurality of market entities in the CTCP in a preset electric quantity market and acquiring the adjustment situation comprise:
adjusting the quoting function of each of the plurality of market entities in the CTCP in a mid-long term electricity market according to following formulas:
ƒᵢ′(p,q)=ƒᵢ(p,q),q∈[0,Sᵢ′],
G^{CBDQ}(p,q)=G(p,q),q∈[0,D₀−Y_{E}],
where ƒᵢ′(p,q) is the quoting function of the power generation entity i after the adjustment, p is a quoted price, q is a quoted quantity, ƒᵢ(p,q) is the quoting function of the power generation entity i before the adjustment, Sᵢ′ is an upper limit of the supply quantity of the power generation entity i after the adjustment, G^{CBDQ}(p,q) is a demand function of the competitive clearing demand electric quantity of an entire power consumption side, G(p,q) is a demand function of the entire power consumption side and Y_{E} is an electric quantity of a demand side participating in the compulsory clearing market; and
acquiring the market clearing situation of the CTCP comprises:
solving an optimized planning problem by taking a social dividend maximization as an objective function and considering a physical constraint of a power system to acquire a market clearing result of the CTCP, wherein the market clearing result comprises a market price λ₀, a clearing electric quantity Qᵢ^{CBSQ} of each of the power generation entities and a clearing electric quantity Qₘ^{CBDQ} of each of power consumption entities.

5. The method according to claim 1, wherein distributing compulsory price settlement part CPSP in the preset electric quantity market according to the market clearing situation of the CTCP comprises:
for the power generation entities participating in the CPSP, acquiring the clearing amount of the CPSP Qᵢ^{CPSQ}=yᵢ and settling the price with λ₀;
for the power consumption side, based on the clearing result of the CTCP, solving an optimized planning problem by taking a maximum of residual consumption as an objective function and considering a physical constraint of a power system to acquire a compulsory price settlement quantity Qₘ^{CPDQ} of a power consumption entity, and settling the price with λ₀.

6. The method according to claim 1, wherein settling and clearing transactions of the plurality of market entities according to a clearing amount and a clearing price comprise:
clearing transactions of the power generation entity and the power consumption entity in the market according to the clearing amount and the clearing price,
in which for the power generation entity i, a market clearing price is λ₀, a total clearing amount is:
$${Q}_{i}^{S} = \{ \begin{matrix}{Q}_{i}^{CBSQ} + {Q}_{i}^{CCSQ} , i ∈ E \\ {Q}_{i}^{CBSQ} , i ∈ J , i ∉ E\end{matrix} ,$$
for the power consumption entity m, the market clearing price is λ₀, the total clearing amount is:
Qₘ^{D}=Qₘ^{CBDQ}+Qₘ^{CCDQ}.

7. A device for clearing electric quantity market, comprising:
a processor; and
a memory for storing instructions executable by the processor;
wherein the processor is configured to perform a method for clearing electric quantity market, the method comprising:
acquiring a residual supply index RSI of each of a plurality of market entities;
judging whether a market power of a market entity exceeds a threshold according to the RSI of the market entity;
adjusting an electric quantity declared by a power generation entity and a market demand electric quantity if the market power of the market entity exceeds the threshold;
evaluating the market power under a new environment and judging whether the market power meets a preset condition;
adjusting a quoting function of each of the plurality of market entities in a competitive transaction clearing part CTCP in a preset electric quantity market and acquiring an adjustment situation if the market power meets the preset condition;
clearing transactions of each of the plurality of market entities in the CTCP in the preset electric quantity market according to the adjustment situation and acquiring a market clearing situation of the CTCP;
distributing compulsory price settlement part CPSP in the preset electric quantity market according to the market clearing situation of the CTCP; and
settling and clearing transactions of the plurality of market entities according to a clearing amount and a clearing price.

8. The device according to claim 7, further comprising adjusting the electric quantity and the market demand electric quantity if the market power does not meet the preset condition.

9. The device according to claim 7, wherein the RSI of each of the plurality of market entities is calculated according to following formulas:
$${I}_{i}^{RSI} = \frac{1}{{D}_{0}} {\sum }_{j \neq i , j ∈ J} {S}_{j} , \\ {D}_{0} = {\sum }_{m ∈ M} {D}_{m} ,$$
where Iᵢ^{RSI} is a RSI of a power generation entity i, D₀ a total demand amount of power consumption of the market, J is a set of the power generation entities participating in a bidding, Sⱼ is an upper limit of a supply quantity of a power generation entity j, M is a set of the demand entities participating in the bidding and Dₘ is a demand quantity of a power consumption entity m.

10. The device according to claim 7, wherein adjusting an electric quantity declared by a power generation entity and a market demand electric quantity comprises:
adjusting the electric quantity declared by the power generation entity and the market demand according to following formulas:
$$\{ \begin{matrix}{x}_{i} = \frac{( {S}_{0} + {nS}_{i} - {\sum }_{j ∈ E} {S}_{j} ) {R}_{0} {D}_{0} - [ {S}_{0} + ( n - 1 ) {S}_{i} - {\sum }_{j ∈ E} {S}_{j} ] {S}_{0}}{{nR}_{0} {D}_{0} - ( n - 1 ) {S}_{0}} \\ {y}_{i} = \frac{( {S}_{0} + {nS}_{i} - {\sum }_{j ∈ E} {S}_{j} ) {R}_{0} {D}_{0} - [ {S}_{0} + ( n - 1 ) {S}_{i} - {\sum }_{j ∈ E} {S}_{j} ] {S}_{0}}{{nR}_{0} {D}_{0} - ( n - 1 ) {S}_{0}} \cdot \frac{{D}_{0}}{{S}_{0}}\end{matrix} , \\ \{ \begin{matrix}{X}_{E} = {S}_{0} - \frac{{S}_{0} - {\sum }_{j ∈ E} {S}_{j}}{{nR}_{0} {D}_{0} - ( n - 1 ) {S}_{0}} {S}_{0} \\ {Y}_{E} = {D}_{0} - \frac{{S}_{0} - {\sum }_{j ∈ E} {S}_{j}}{{nR}_{0} {D}_{0} - ( n - 1 ) {S}_{0}} {D}_{0}\end{matrix} , \\ {S}_{i}^{′} = \frac{( {S}_{0} - {\sum }_{j ∈ E} {S}_{j} ) ( {S}_{0} - {R}_{0} {D}_{0} )}{{nR}_{0} {D}_{0} - ( n - 1 ) {S}_{0}} ,$$
where E is an electric quantity set of the adjusted entity i participating in a compulsory clearing market, n is the number of the power generation entities in the set E, S₀ is a total power generation supply quantity of the market, Sᵢ is an upper limit of the supply quantity of the power generation entity i, R₀ is a reference RSI, and D₀ is a total demand amount of power consumption of the market;
adjusting the quoting function of each of the plurality of market entities in the CTCP in a preset electric quantity market and acquiring the adjustment situation comprise:
adjusting the quoting function of each of the plurality of market entities in the CTCP in a mid-long term electricity market according to following formulas:
ƒᵢ′(p,q)=ƒᵢ(p,q),q∈[0,Sᵢ′],
G^{CBDQ}(p,q)=G(p,q),q∈[0,D₀−Y_{E}],
where ƒᵢ′(p,q) is the quoting function of the power generation entity i after the adjustment, p is a quoted price, q is a quoted quantity, ƒᵢ(p,q) is the quoting function of the power generation entity i before the adjustment, Sᵢ′ is an upper limit of the supply quantity of the power generation entity I after the adjustment, G^{CBDQ}(p,q) is a demand function of the competitive clearing demand electric quantity of an entire power consumption side, G(p,q) is a demand function of the entire power consumption side and Y_{E} is an electric quantity of a demand side participating in the compulsory clearing market; and
acquiring the market clearing situation of the CTCP comprises:
solving an optimized planning problem by taking a social dividend maximization as an objective function and considering a physical constraint of a power system to acquire a market clearing result of the CTCP, wherein the market clearing result comprises a market price λ₀, a clearing electric quantity Qᵢ^{CBSQ} of each of the power generation entities and a clearing electric quantity Qₘ^{CBDQ} of each of power consumption entities.

11. The device according to claim 7, wherein distributing compulsory price settlement part CPSP in the preset electric quantity market according to the market clearing situation of the CTCP comprises:
for the power generation entities participating in the CPSP, acquiring the clearing amount of the CPSP Qᵢ^{CPSQ}=yᵢ and settling the price with λ₀;
for the power consumption side, based on the clearing result of the CTCP, solving an optimized planning problem by taking a maximum of residual consumption as an objective function and considering a physical constraint of a power system to acquire a compulsory price settlement quantity Qₘ^{CPDQ} of a power consumption entity, and settling the price with λ₀.

12. The device according to claim 7, wherein settling and clearing transactions of the plurality of market entities according to a clearing amount and a clearing price comprise:
clearing transactions of the power generation entity and the power consumption entity in the market according to the clearing amount and the clearing price,
in which for the power generation entity i, a market clearing price is λ₀, a total clearing amount is:
$${Q}_{i}^{S} = \{ \begin{matrix}{Q}_{i}^{CBSQ} + {Q}_{i}^{CCSQ} , i ∈ E \\ {Q}_{i}^{CBSQ} , i ∈ J , i ∉ E\end{matrix} ,$$
for the power consumption entity m, the market clearing price is λ₀, the total clearing amount is:
Qₘ^{D}=Qₘ^{CBDQ}+Qₘ^{CCDQ}.

13. A non-transitory computer-readable storage medium having stored therein instructions that, when executed by a processor of a terminal, cause the terminal to perform a method for clearing electric quantity market, the method comprising:
acquiring a residual supply index RSI of each of a plurality of market entities;
judging whether a market power of a market entity exceeds a threshold according to the RSI of the market entity;
adjusting an electric quantity declared by a power generation entity and a market demand electric quantity if the market power of the market entity exceeds the threshold;
evaluating the market power under a new environment and judging whether the market power meets a preset condition;
adjusting a quoting function of each of the plurality of market entities in a competitive transaction clearing part CTCP in a preset electric quantity market and acquiring an adjustment situation if the market power meets the preset condition;
clearing transactions of each of the plurality of market entities in the CTCP in the preset electric quantity market according to the adjustment situation and acquiring a market clearing situation of the CTCP;
distributing compulsory price settlement part CPSP in the preset electric quantity market according to the market clearing situation of the CTCP; and
settling and clearing transactions of the plurality of market entities according to a clearing amount and a clearing price.
